(19) United States
(12) Patent Application Publication
(10) Pub. No.: US 2015/0063982 A1
(43) Pub. Date: Mar. 5, 2015

(54) MULTI-STAGE INFLOW TURBINE PUMP FOR PARTICLE COUNTERS

(71) Applicant: Particles Plus, Inc., Canton, MA (US)

(72) Inventors: David PARISEAU, Los Altos, CA (US); Craig D. Adams, Jacksonville, OR (US)

(21) Appl. No.: 14/475,347

(22) Filed: Sep. 2, 2014

Related U.S. Application Data
(60) Provisional application No. 61/872,729, filed on Sep. 1, 2013.

(51) Int. Cl. F04D 19/02; G01N 21/49; G01N 15/14

(52) U.S. Cl. CPC F04D 19/022; G01N 15/1404; G01N 21/49; G01N 2201/06113
USPC 415/115

(57) ABSTRACT

An airborne, gas particle counter, includes an inflow multiple stage turbine pump inducing flow through a particle counter. The turbine pump includes a rotor and stator assemblies and establishes gas flow through a second housing, which defines a view volume where particles are counted by light scattering or obscuration of a beam intersecting the light flow path. Intersecting rotor and stator assemblies limit particles to those suspended in the gas flow. The pump assembly includes integral flow paths limiting the need for external tubing.

### CROSS-REFERENCE TO RELATED APPLICATION

This application claims priority to U.S. Provisional Application Ser. No. 61/872,729 filed on Sep. 1, 2013, titled MULTI-STAGE INFLOW TURBINE PUMP FOR PARTICLE COUNTERS by inventors David PARISEAU et al., the entire disclosure of which is hereby incorporated herein by reference.

### FIELD OF THE INVENTION

The present invention relates to instruments for detection of particles and, more specifically to counting or measuring particles in a gas stream, including air.

### BACKGROUND ART

A typical counter for particles suspended in a fluid is disclosed in U.S. Pat. No. 6,031,610 (herein “the '610 Patent” and incorporated by reference). The '610 Patent describes a particle counter in which gas flows through a space within an enclosure, known as a view volume, monitored by a laser beam. The beam intersects the gas flow and illuminates particles flowing through the view volume. Light obscured by the particles, or scattered by the particles, is detected by an electronic detector sensitive to the obscuration or scattering of light. The resultant electrical signals are interpreted as particle counts.

The need for improved particle counters is largely driven by the semiconductor manufacturing industry. Silicon wafers have become larger in size while, at the same time, line widths and features on chips laid out on the wafer have become smaller. Chip size has become larger with more complex functions on each chip. Defects and particles which previously caused little harm now can render a large portion of a wafer useless. Thus, the role of small particles becomes increasingly important in monitoring quality of chip production. Air quality in clean rooms is especially critical at many stages of chip production. Semiconductor companies routinely monitor air quality at all stages of chip production.

While various improvements have been made in particle counters themselves, including the optics, nozzle characteristics, lasers and laser cavities, detector attributes and signal electronics, little attention has been paid to the integration of quiet and efficient pumps that are used to maintain the air flow through the view volume. Typically, pumps used in prior art particle counters use pistons, intermission gears or rotors, diaphragms or vanes to move a fluid carrier medium, such as air. However, most prior art pumps are costly, noisy, generate heat, and are somewhat inefficient. Therefore, what is needed is a pump for particle counter that provide for ease of integration into the particle counter.

### SUMMARY OF THE INVENTION

What is disclosed in accordance with the various aspects of the present invention is an improved pump for a particle counter, which provides for ease of integration into the particle counter with little, if no, pluming or tubing, low pulse flow, quiet operation, relatively cool running and is efficient at flow rates and pressures used in particle counters. The performance objectives have been achieved in a particle counter. The particle counter includes a flow of sample gas through a flow cell propelled by a pump. In accordance with the present invention, the pump is of the inflow multiple stage turbine type wherein an inflow multiple stage turbine type pump: including a pump housing of efficient compact size and including an inter chamber, in which are set a plurality of stators of a particular aerodynamic shape, each set in rows that interact with a rotating airfoils of a particular aerodynamic shape mounted to a multi-staged rotor that is attached to a rotating shaft in a manner that allows gas flow to communicate within the volumetric space. A motor drives the shaft rotating a rotor using a controller provided with feedback from a flow meter so that a desired air volume may be pumped through the gas flow cell. The inflow multiple stage turbine is efficient, quiet, and does not introduce particles because clearance is maintained between interacting stators and rotor blades, and with surrounding chamber walls. The advantages of an inflow design includes: compact packaging, noise-reduction compared to typical centrifugal pump designs, and increased cooling of the motor electronics components.

### BRIEF DESCRIPTION OF THE DRAWINGS

FIG. 1 is a block diagram of an apparatus or particle counter in accordance with the present invention.

FIG. 2 is a cross section of the apparatus of FIG. 1, with a turbine's inter rotor chamber in accordance with the present invention.

FIG. 3 and FIG. 3b are exploded views of the apparatus of FIG. 1 that includes and shows a pump, motor, and filter in accordance with the present invention.

FIG. 4 is a particle counter or system in accordance with the present invention with the outer shell or body removed.

FIG. 5 is a perspective view of the apparatus of FIG. 1 in accordance with the present invention.

### DETAILED DESCRIPTION

As will be apparent to those of skill in the art upon reading this disclosure, each of the aspects described and illustrated herein has discrete components and features which may be readily separated from or combined with the features and aspects to form embodiments, without departing from the scope or spirit of the present invention. Any recited method can be carried out in the order of events recited or in any other order which is logically possible. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein.

All publications and patents cited in this specification are herein incorporated by reference as if each individual publication or patent were specifically and individually indicated to be incorporated by reference and are incorporated herein by reference to disclose and describe the methods and/or system in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

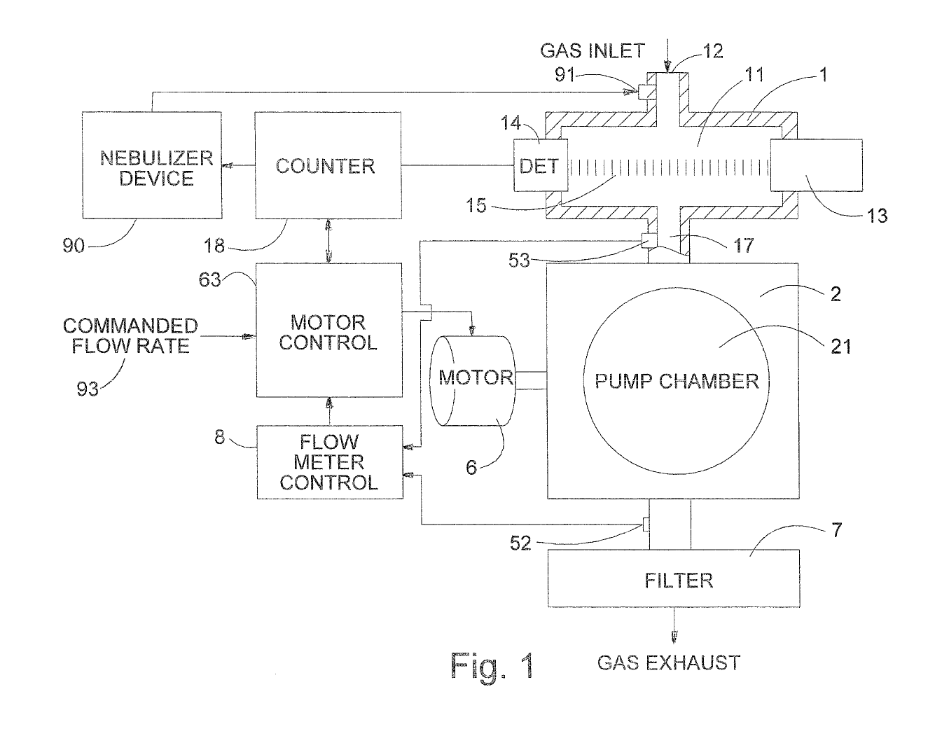

Referring now to FIG. 1, a system is shown that includes a particle view volume 11, within a gas flow cell, and defined within a particle counter housing 1, which may be a block of metal or other material that does not generate particles. A first of two intersecting bores accommodates a gas inlet port 12 that faces a gas outlet port 17. A second orthogonal bore seats laser 13 that directs a beam 15 toward detector 14, intersecting the gas flow stream between gas inlet port 12 and gas outlet port 17. The beam 15 illuminates individual particles flowing from the gas inlet port 12 to the gas outlet port 17 within the gas flow cell. The illuminated zone formed by the beam 15 and the gas flow path, as seen by the detector 14, is the particle view volume 11. The system also includes a filter 7, which is discussed in detail below.

The beam 15 has a characteristic changed, either by obscuration of the beam 15, in which case the detector 14 is in line with the beam 15 (as shown in FIG. 1), or by scattering, in which case the detector 14 is at an angle to the axis of the beam 15 so that only light scattered by particles is detected and not light coming directly from the laser 13. Gas flow cells of the type described above are illustrated in FIG. 1 the '610 Patent. The gas outlet port 17 is connected to a main turbine housing 2. The turbine housing 2 feeds gas to a pump that includes a turbine chamber 21. The turbine chamber 21 pulls gas through the gas flow cell from the gas inlet port 12. Rotors and stator in the main turbine housing 2 are described below and are driven by a motor 6. The motor 6 is an AC motor in accordance with one aspect of the present invention. In accordance with another aspect of the present invention, the motor 6 is a DC motor.

In accordance with some aspect of the present invention, the motor 6 can either free-run (with the flow controlled by a critical orifice in the outlet port 17, not shown) or operate under control of a motor controller 63, providing a command signal indicating the speed at which the motor 6 is to operate. Gas pulled through the gas flow cell by the pump, which includes the turbine chamber 21 and the motor 6, moves through the gas outlet port 17 and passes across a flow meter transducer port 53 before being exhausted into the turbine chamber 21. Flow meter 8 communicates with transducer port 52 located on the exit of the turbine chamber 21. The flow meter 8 compares pressure differential with the flow meter transducer port 53 and measures output gas velocity and sends a signal back to motor controller 63. The motor controller 63 uses the flow meter signal for a comparison with a commanded motor speed signal delivered on a line 93 from an external source.

The comparison of the two signals (the flow meter signal and the commanded motor speed signal) results in an error signal. The error signal is used to continuously adjust the speed of the motor 6 so that the motor 6 will turn a rotor at a velocity so that the desired output flow rate is achieved. Though flow in this example is inferred using the differential pressure between the two transducer ports 52 and 53, this scope of the present invention is not limited to this type of flow sensor. In accordance with the various aspects of the present invention, other flow sensor types (for example, hot-air anemometers, mechanical rotation, etc.) may be deployed. A signal from a counter 18 may also be used to influence the motor controller 63.

If the particle count rate is too fast and exceeds the capacity of the system, the flow may be slowed to allow the counter to be within an accurate measuring range. For this purpose, an output signal from the counter 18 is communicated to the motor controller 63. In in accordance with one aspect of the present invention, the counter 18 might scale the actual counts against the actual flow rate in order to estimate the counts per unit volume. A motor speed adjustment may also be commanded on the line 93 to compensate for increased loads before the motor 6, such as long hose or constricted inlet on the gas inlet port 12. For automatic calibration, nebulizer device 90 may receive communication from the counter 18 to release a controlled quantity of calibrated size particles to the gas inlet port 12 through a calibration port 91. The counter 18 will then compare the known particle sizes of the particulate being introduced through the calibration port 91 to a known scale.

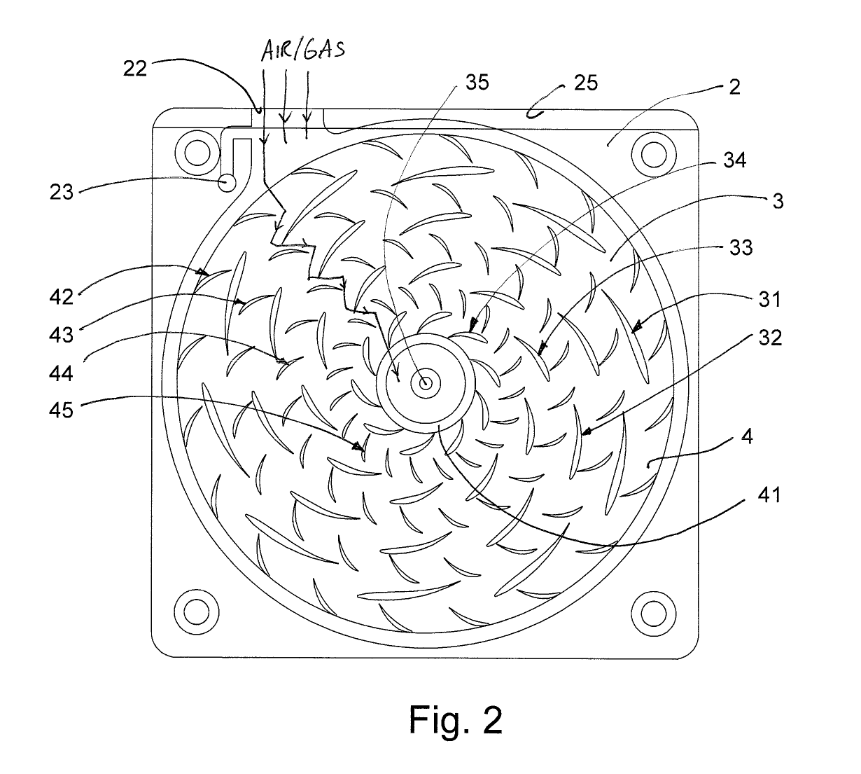

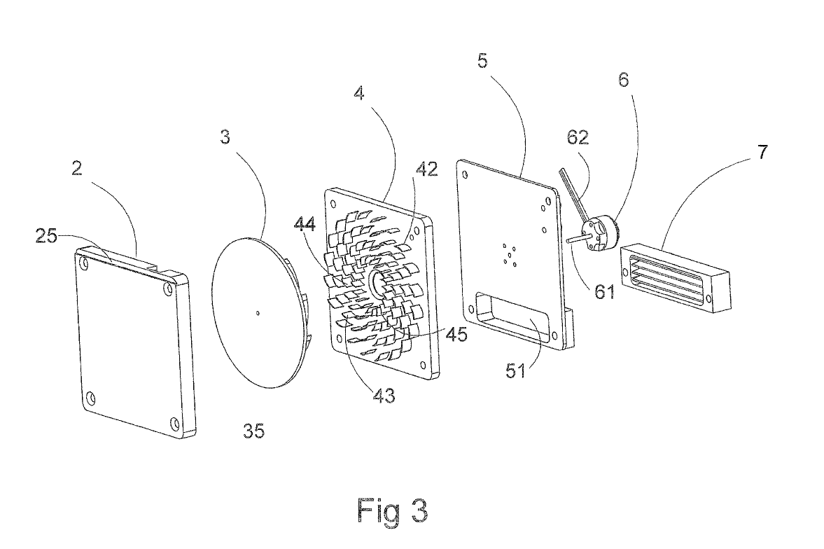

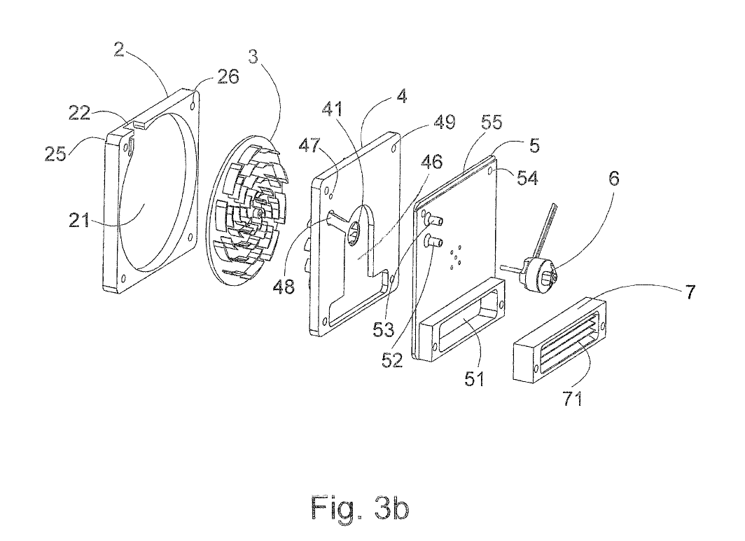

Referring now to FIG. 2 shows a rotor 3 located within the main turbine chamber 21 in accordance with various aspects of the present invention. On the rotor 3 are located rows of aerodynamically shaped rotor vanes: first row 31, second row 32, third row 33, and fourth row 34. The rotor 3 rotates on an axis 35 about a motor shaft 61, which is shown in FIG. 3. The vanes of the rotor 3 come in close proximity with non-rotating stators mounted on stator assembly 4. On the stator assembly 4 are located four rows of aerodynamically shaped vanes: first row 42, second row 43, third row 44, and fourth row 45. The rotor 3 rotates about the shaft 35, while the stator assembly 4 is fixed to the main pump assembly, such as the turbine housing 2 of FIG. 1. The interaction between the aerodynamically shaped vanes on the rotor 3 and the aerodynamically shaped vanes affixed to the stator assembly 4 induce or cause a pressure differential between the consecutive rows of vanes inducing a greater pressure differential between an inlet port 22 and an exhaust port 41. The port 22 is connected to the particle view volume 11 and induces flow through the exhaust port 41. A dovetail 25 interconnects with the housing 1 of the particle counter and to the main turbine housing 2 to interconnect the two components. A flowmeter inlet port 23 communicates with inlet port 22. The flowmeter inlet port 23 communicates with inlet port 53 of FIG. 1.

Referring now to FIG. 3, an exploded view of the system of FIG. 1 and FIG. 2 are shown in accordance with the aspects of the present invention and include: the main turbine housing 2, the rotor 3, the stator assembly 4, a back head assembly 5, the motor 6, and the filter 7. In accordance with one aspect of the present invention, the filter 7 is a HEPA filter assembly. The system also includes the stator assembly 4 with its four rows of stators 42, 43, 44, 45. The back head assembly 5 defines an exhaust port 51. The motor 6 includes the motor shaft 61 and main motor wires 62.

Referring now to FIG. 3b, an exploded view of the system of FIG. 1 and FIG. 2 is shown in accordance with the aspects of the present invention. The system includes the main turbine assembly 2, the rotor 3, the stator assembly 4, the back head assembly 5, the motor 6, and the HEPA filter assembly 7, which defines a main exhaust port 71. The main turbine housing 2 includes the dovetail 25 and defines main attachment screw holes 26, the inlet port 22, and the main turbine chamber 21. The stator assembly 4 defines the exhaust port 41, a main flow chamber 46, a flow meter communication port 47 that communicates between the flow meter inlet port 23 of FIG. 2 and the flowmeter port transducer 53. The stator assembly 4 further defines a flowmeter downstream port chamber 48 and main attachment screw holes 49 in accordance with one aspect of the present invention. The back head assembly 5 includes a mounting dovetail 55 and defines main attachments screw holes 54, the upstream flowmeter transducer port 53, the downstream transducer port 52, the exhaust port 51.

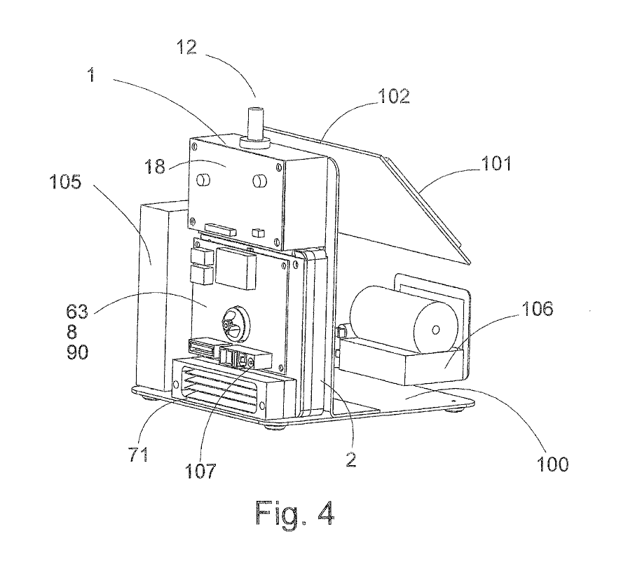

Referring now to FIG. 4, the system of FIG. 1 and FIG. 2 is shown in accordance with one aspect of the present invention, with outside body or shell removed. The system includes a chassis 100, a touchscreen 101, an electronic board 102, a removable battery pack 105, a printer 106, an external power inlet 107, and the exhaust port 71. The system also includes the turbine chamber 2, the particle counter housing 1, the gas inlet port 12, and the counter 18. In accordance with one aspect of the present invention, the counter 18 is an electronic control board and in accordance with one aspect of the present invention the counter 18 includes any combination of the following: the motor controller 63, the flowmeter 8, and the nebulizer device 90. In accordance with one aspect of the present invention the counter 18 includes only one or none of the following: the motor controller 63, the flowmeter 8, and the nebulizer device 90.

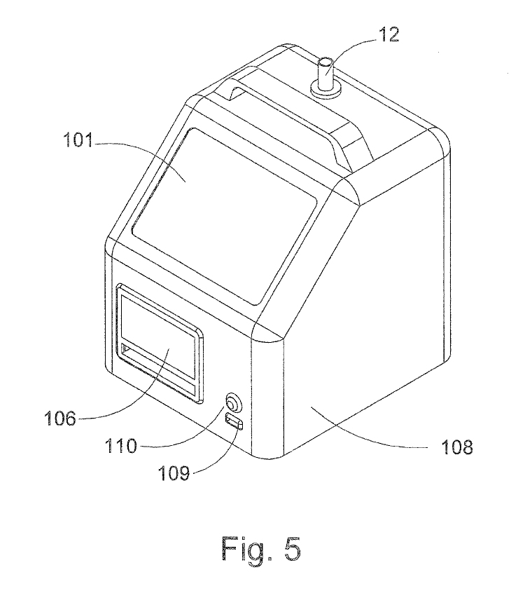

Referring now to FIG. 5, an exterior of the system of FIG. 1 is shown in accordance with the aspects of the present invention As indicated, the system includes the inlet port 12, the touchscreen 101, the printer 106, a main body 108, a USB port 109, and an accessory power port 110.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

In accordance with the teaching of the present invention a computer and a computing device are articles of manufacture. Other examples of an article of manufacture include: an electronic component residing on a mother board, a server, a mainframe computer, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods.

The article of manufacture (e.g., computer or computing device) includes a non-transitory computer readable medium or storage that includes a series of instructions, such as computer readable program steps or code encoded therein. In certain aspects of the present invention, the non-transitory computer readable medium includes one or more data repositories. Thus, in certain embodiments that are in accordance with any aspect of the present invention, computer readable program code (or code) is encoded in a non-transitory computer readable medium of the computing device. The processor, in turn, executes the computer readable program code to create or amend an existing computer-aided design using a tool. In other aspects of the embodiments, the creation or amendment of the computer-aided design is implemented as a web-based software application in which portions of the data related to the computer-aided design or the tool or the computer readable program code are received or transmitted to a computing device of a host.

An article of manufacture or system, in accordance with various aspects of the present invention, is implemented in a variety of ways: with one or more distinct processors or microprocessors, volatile and/or non-volatile memory and peripherals or peripheral controllers; with an integrated microcontroller, which has a processor, local volatile and non-volatile memory, peripherals and input/output pins; discrete logic which implements a fixed version of the article of manufacture or system; and programmable logic which implements a version of the article of manufacture or system which can be reprogrammed either through a local or remote interface. Such logic could implement either a control system either in logic or via a set of commands executed by a soft-processor.

Accordingly, the preceding merely illustrates the various aspects and principles of the present invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the various aspects discussed and described herein. Rather, the scope and spirit of present invention is embodied by the appended claims.

What is claimed is:

1. An apparatus for a particle counter including a gas flow path extending through a volumetric space illuminated by a beam of light that is obscured or scattered by particles in a flowing stream of gas in the gas flow path, the apparatus comprising an inflow multiple stage turbine pump including an inter chamber, in which are set a plurality of stators with each of the plurality of stators set in rows that interact with a plurality of rotating airfoils, the airfoils being mounted to a rotor that is attached to a shaft in a manner that allows gas flow communication with the volumetric space and the shaft being set in the pump to provide locating clearance and rotating forces upon the multi-staged rotor.

2. The apparatus of claim 1 further comprising a housing and channels integral into the housing to communicate to a flowmeter positioned to measure the flowing stream of gas through the volumetric space, the flowmeter generating an electrical signal representing flow velocity of the flowing stream.

3. The apparatus of claim 2 further comprising, a motor operating the pump and having a motor controller adjusting flow velocity through the volumetric space to a desired flow velocity represented by an electrical signal.

4. The apparatus of claim 3 further comprising, an electrical feedback circuit receiving the electrical signal representing the flow velocity and the electrical signal representing the desired flow velocity, the feedback circuit generating an error signal by comparing these signals, and transmitting this error signal transmitted to the motor controller thereby adjusting the flow velocity through the volumetric space.

5. The apparatus of claim 1 further comprising a HEPA filter mounted in the gas flow path between volumetric space and the exterior of the pump assembly.
